(19) United States
(12) Patent Application Publication
(10) Pub. No.: US 2013/0325529 A1
(43) Pub. Date: Dec. 5, 2013

(54) Analyzing Engineering Requirements

(71) Applicants: Jeffrey H. Babylon, Loveland, CO (US); James D. Jamison, III, Aurora, CO (US); Michael J. Musumeci, Rochester, NY (US)

(72) Inventors: Jeffrey H. Babylon, Loveland, CO (US); James D. Jamison, III, Aurora, CO (US); Michael J. Musumeci, Rochester, NY (US)

(73) Assignee: International Business Machines Corporation, Armonk, NY (US)

(21) Appl. No.: 13/482,635

(22) Filed: May 29, 2012

(51) Int. Cl. G06Q 10/06

(52) U.S. Cl. 705/7.11

(57) ABSTRACT

Analyzing engineering requirements, including: identifying, by an engineering requirements analysis component, a plurality of analysis criteria areas for an engineering project; identifying, by the engineering requirements analysis component, a plurality of analysis criteria for each analysis criteria area; setting, by the engineering requirements analysis component, a criteria weight for each analysis criterion; receiving, by the engineering requirements analysis component, a criterion score for each analysis criterion; and calculating, by the engineering requirements analysis component, a project score for the engineering project in dependence upon the criterion score for each analysis criterion and the criteria weight for each analysis criterion.

### BACKGROUND OF THE INVENTION

1. Field of the Invention

The field of the invention is analytics, or, more specifically, methods, apparatus, and products for analyzing engineering requirements.

2. Description of Related Art

Requirements engineering is a systems and software engineering process which covers all of the activities involved in discovering, documenting and maintaining a set of requirements for a computer-based system. Determining the health and progress of such a process is typically focused on specific aspects of a requirements engineering project. Ascertaining the health and progress of specific aspects of the requirements engineering project does not give an overall view of the health and progress of the project as a whole.

### SUMMARY OF THE INVENTION

Methods, apparatus, and products for analyzing engineering requirements, including: identifying, by an engineering requirements analysis component, a plurality of analysis criteria areas for an engineering project; identifying, by the engineering requirements analysis component, a plurality of analysis criteria for each analysis criteria area; setting, by the engineering requirements analysis component, a criteria weight for each analysis criterion; receiving, by the engineering requirements analysis component, a criterion score for each analysis criterion; and calculating, by the engineering requirements analysis component, a project score for the engineering project in dependence upon the criterion score for each analysis criterion and the criteria weight for each analysis criterion.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example EAPA Host useful in analyzing engineering requirements according to embodiments of the present invention.

FIG. 2 sets forth a flow chart illustrating an example method for analyzing engineering requirements according to embodiments of the present invention.

FIG. 3 sets forth a flow chart illustrating a further example method for analyzing engineering requirements according to embodiments of the present invention.

FIG. 4 sets forth a flow chart illustrating a further example method for analyzing engineering requirements according to embodiments of the present invention.

### DETAILED DESCRIPTION OF EXAMPLE EMBODIMENTS

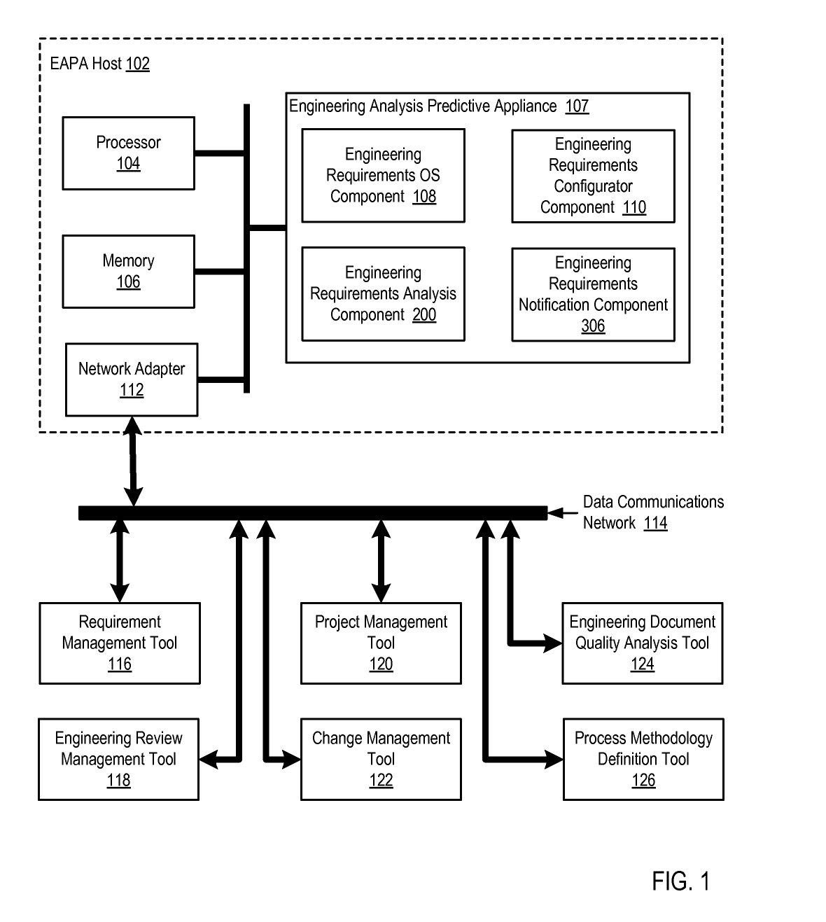

Example methods, apparatus, and products for analyzing engineering requirements in accordance with embodiments of the present invention are described with reference to the accompanying drawings, beginning with FIG. 1. FIG. 1 sets forth a block diagram of automated computing machinery comprising an example EAPA Host (102) useful in analyzing engineering requirements according to embodiments of the present invention. The EAPA Host (102) of FIG. 1 includes at least one computer processor (104) or ‘CPU’ as well as computer memory (106) which is connected to the processor (104), for example, via a high speed memory bus and bus adapter.

The EAPA host (102) of FIG. 1 includes an engineering analysis predictive appliance (107). The engineering analysis predictive appliance (107) of FIG. 1 may be embodied as a module of automated computing machinery useful in analyzing engineering requirements according to embodiments of the present invention. In one embodiment, the engineering analysis predictive appliance (107) may be embodied as a standalone computing device that includes a computer processor and computer memory that includes computer program instructions for analyzing engineering requirements in accordance with embodiments of the present invention. In other embodiments, the engineering analysis predictive appliance (107) may be embodied within a larger computing system. The engineering analysis predictive appliance (107) of FIG. 1 includes four distinct components: an engineering requirements OS component (108), an engineering requirements configurator component (110), an engineering requirements analysis component (200), and an engineering requirements notification component (306).

In the example of FIG. 1, the engineering requirements OS component (108) provides a user interface that enables access to requirements data such that users can effect requirements engineering analysis activities on that data. The engineering requirements OS component (108) provides a user interface that provides real time feedback regarding the health of a project and provides actionable events for the user related to defined requirements quality activities.

In the example of FIG. 1, the engineering requirements configurator component (110) uses the associations between information technology process methodology and requirements engineering and quality activities defined across the requirements lifecycle to identify actionable events and data needs as the lifecycle progresses. Such associations also enable tailoring of criteria uses in predictive analysis.

In the example of FIG. 1, the engineering requirements analysis module (200) is a module of computer program instructions for analyzing engineering requirements according to embodiments of the present invention. The engineering requirements analysis component (200) of FIG. 1 may be configured to establish the goals, functions and constraints of hardware and software systems, including identifying and analyzing the qualitative risks associated with a particular system. The engineering requirements analysis component (200) of FIG. 1 may be configured to analyze engineering requirements for an engineering project by identifying a plurality of analysis criteria areas for an engineering project. Each analysis criteria area represents a particular aspect of an engineering project. For example, one analysis criteria area may include an ‘artifact quality’ area that describes the development of all documentation related to the engineering project, a ‘stability’ area that describes the stability of components developed as part of the engineering project, a ‘risk assessment’ area that describes various risk aspects associated with a product developed as part of an engineering project, and so on. Identifying a plurality of analysis criteria areas for an engineering project may be carried out, for example, by receiving input from a user such a requirements engineer identifying the plurality of analysis criteria areas, by inferring the plurality of analysis criteria areas based on a project type, and so on. For example, if the engineering project is directed to the development and implementation of a data processing system, the engineering requirements analysis component (200) may be configured to identify a plurality of base analysis criteria areas such as ‘performance’ criteria area, a ‘documentation development’ criteria area, and so on.

The engineering requirements analysis component (200) of FIG. 1 may be further configured to analyze engineering requirements for an engineering project by identifying a plurality of analysis criteria for each analysis criteria area. Each analysis criteria area can include a plurality of analysis criteria. Consider an example in which the analysis criteria area is an ‘artifact quality’ area that describes the development of all documentation related to the engineering project. In such an example, the ‘artifact quality’ area may include a plurality of analysis criteria. Examples of such analysis criteria can include, for example, a ‘process model’ criterion that describes the extent to which process models for aspects of the engineering project have been developed, a ‘user documentation’ criterion that describes the extent to which user documentation has been developed for aspects of the engineering project, a ‘system requirements documentation’ criterion that describes the extent to which documentation has been developed to describe system requirements for installing components associated with the engineering project, and so on. Each analysis criterion can be used to ascertain a more thorough understanding of overall progress that has been made in the engineering project with respect to a particular analysis criteria area. Identifying a plurality of analysis criteria for each analysis criteria area may be carried out, for example, by receiving input from a user such a requirements engineer identifying the plurality of analysis criteria within a particular analysis criteria area, by associating a default set of analysis criteria with a particular analysis criteria area, and so on.

The engineering requirements analysis component (200) of FIG. 1 may be further configured to analyze engineering requirements for an engineering project by setting a criteria weight for each analysis criterion. The criteria weight for each analysis criterion represents the relative importance of a particular analysis criterion within an analysis criteria area. Setting a criteria weight for each analysis criterion may be carried out, for example, by receiving input from a user such a requirements engineer identifying the criteria weight for each analysis criterion and storing such information in a data structure such as a criteria weight table.

The engineering requirements analysis component (200) of FIG. 1 may be further configured to analyze engineering requirements for an engineering project by receiving a criterion score for each analysis criterion. The criterion score for an analysis criterion represents the extent to which a particular analysis criterion has been satisfied. Consider an example in which user documentation for a particular product developed as part of an engineering project was 50% complete while process models for the particular product developed as part of the engineering project was 80% complete. In such an example the criterion score for the ‘system requirements documentation’ analysis criterion can be set to ‘0.5’ while the criterion score for the ‘process model’ analysis criterion can be set to ‘0.8.’ Receiving a criterion score for each analysis criterion may be carried out, for example, by receiving input from a user such a requirements engineer identifying the criterion score for each analysis criterion, by calculating the criterion score for each analysis criterion, by any combination thereof, and so on.

The engineering requirements analysis component (200) of FIG. 1 may be further configured to analyze engineering requirements for an engineering project by calculating a project score for the engineering project in dependence upon the criterion score for each analysis criterion and the criteria weight for each analysis criterion. The project score represents the extent to which measurable objectives of the engineering project as a whole have been met. Calculating a project score for the engineering project may therefore be carried out by using the criterion score for each analysis criterion in every analysis criteria area and applying the criteria weight for each analysis criterion to each criterion score to determine a properly weighted, cumulative score for the entire project.

The example EAPA host (102) of FIG. 1 includes a network adapter (112) for data communications over a data communications network (114). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for analyzing engineering requirements according to embodiments of the present invention include modems for wired dial-up communications, Ethernet (IEEE 802.3) adapters for wired data communications network communications, and 802.11 adapters for wireless data communications network communications.

In the example of FIG. 1, the EAPA host (102) may be configured for data communications over the data communications network (114) to communicate with a requirement management tool (116), engineering review management tool (118), project management tool (120), change management tool (122), engineering document quality analysis tool (124), process methodology definition tool (126), and other tools as with occur to those of skill in the art.

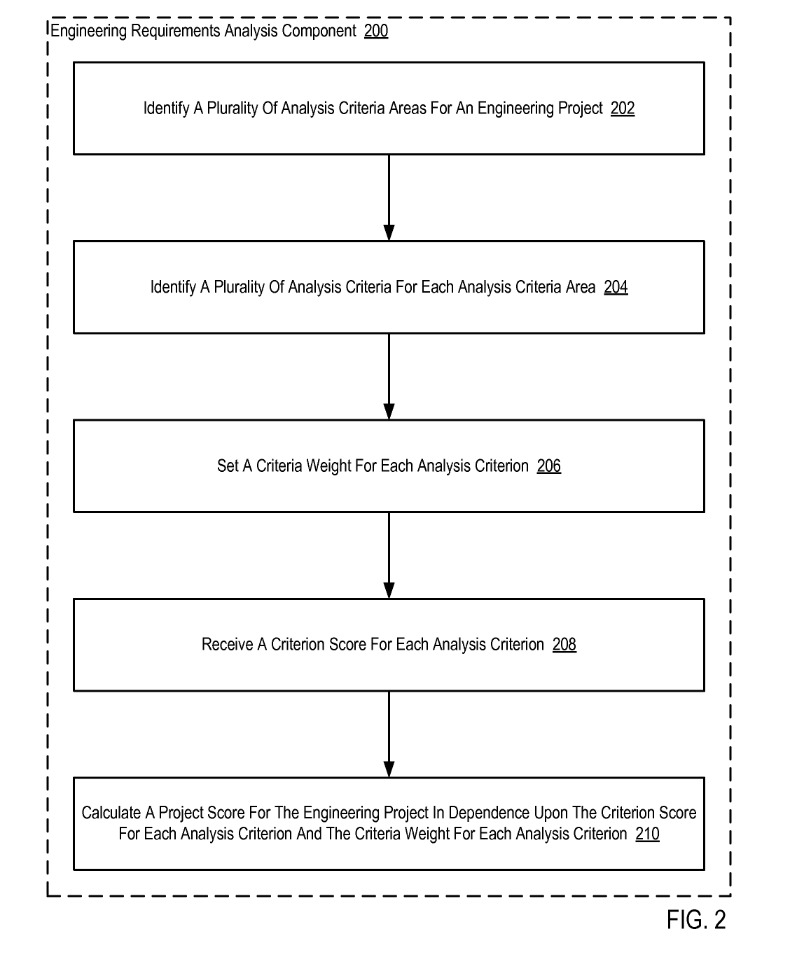

For further explanation, FIG. 2 sets forth a flow chart illustrating an example method for analyzing engineering requirements according to embodiments of the present invention. The example method of FIG. 2 includes an engineering requirements analysis component (200). The engineering requirements analysis component (200) of FIG. 2 may be configured to establish the goals, functions and constraints of hardware and software systems, including identifying and analyzing the qualitative risks associated with a particular system. The engineering requirements analysis component (200) may be embodied, for example, as a module of computer program instructions executing on computer hardware.

The example method of FIG. 2 includes identifying (202), by an engineering requirements analysis component (200), a plurality of analysis criteria areas for an engineering project. In the example method of FIG. 2, an analysis criteria area represents a particular aspect of an engineering requirements project. For example, one analysis criteria area may include an ‘artifact quality’ area that describes the development of all documentation related to the engineering requirements project, a ‘stability’ area that describes the stability of components developed as part of the engineering project, a ‘risk assessment’ area that describes various risk aspects associated with a product developed as part of an engineering project, and so on. In the example method of FIG. 2, identifying (202) a plurality of analysis criteria areas for an engineering project may be carried out, for example, by receiving input from a user such a requirements engineer identifying the plurality of analysis criteria areas, by inferring the plurality of analysis criteria areas based on a project type, and so on. For example, if the engineering project is directed to the development of a software application, the engineering requirements analysis component (200) may be configured to identify (202) a plurality of base analysis criteria areas such as ‘performance’ criteria area, a ‘documentation development’ criteria area, and so on.

The example method of FIG. 2 also includes identifying (204), by the engineering requirements analysis component (200), a plurality of analysis criteria for each analysis criteria area. In the example method of FIG. 2, each analysis criteria area can include a plurality of analysis criteria. Consider an example in which the analysis criteria area is an ‘artifact quality’ area that describes the development of all documentation related to the engineering project. In such an example, the ‘artifact quality’ area may include a plurality of analysis criteria. Examples of such analysis criteria can include, for example, a ‘process model’ criterion that describes the extent to which process models for aspects of the engineering project have been developed, a ‘user documentation’ criterion that describes the extent to which user documentation has been developed for aspects of the engineering project, a ‘system requirements documentation’ criterion that describes the extent to which documentation has been developed to describe system requirements for installing components associated with the engineering project, and so on. Each analysis criterion can be used to ascertain a more thorough understanding of overall progress that has been made in the engineering project with respect to a particular analysis criteria area. In the example method of FIG. 2, identifying (204) a plurality of analysis criteria for each analysis criteria area may be carried out, for example, by receiving input from a user such a requirements engineer identifying the plurality of analysis criteria within a particular analysis criteria area, by associating a default set of analysis criteria with a particular analysis criteria area, and so on.

The example method of FIG. 2 also includes setting (206), by the engineering requirements analysis component (200), a criteria weight for each analysis criterion. In the example method of FIG. 2, the criteria weight for each analysis criterion represents the relative importance of a particular analysis criterion within an analysis criteria area. Setting (206) a criteria weight for each analysis criterion may be carried out, for example, by receiving input from a user such a requirements engineer identifying the criteria weight for each analysis criterion and storing such information in a data structure such as a criteria weight table. An example of a criteria weight table is included below in Table 1:

TABLE 1
Criteria Weight Table

| Analysis Criteria Area | Analysis Criterion | Weight |
|---|---|---|
| Artifact Quality | Process Model | .2 |
| Artifact Quality | User Documentation | .1 |
| Artifact Quality | System Reqs Documentation | .2 |
| Stability | Errors | .3 |
| Stability | Dependencies | .1 |

In the example set forth in Table 1, criteria weights are set forth for analysis criteria in two analysis criteria areas: ‘artifact quality’ and ‘stability.’ In the ‘artifact quality’ analysis criteria area, three analysis criterion are weighted: the ‘process model’ analysis criterion in given a weight of 0.2, the ‘user documentation’ analysis criterion is given a weight of 0.1, and the ‘system requirements documentation’ analysis criterion is given a weight of 0.2. In such an example, more weight is given to the ‘process model’ analysis criterion and the ‘system requirements documentation’ analysis criterion than is given to the ‘user documentation’ analysis criterion. Stated differently, the extent to which the ‘process model’ analysis criterion is satisfied and the extent to which the ‘system requirements documentation’ analysis criterion is satisfied will have more impact when determining whether the ‘artifact quality’ analysis criteria area is satisfied than the extent to which the ‘user documentation’ analysis criterion is satisfied. Readers will appreciate that the weights described above merely represent a value of relative weightings—there is no requirement that the total amount of weights assigned equals a certain value such as 1.

The example method of FIG. 2 also includes receiving (208), by the engineering requirements analysis component (200), a criterion score for each analysis criterion. In the example method of FIG. 2, the criterion score for an analysis criterion represents the extent to which a particular analysis criterion has been satisfied. Consider an example in which user documentation for a particular product developed as part of an engineering project was 50% complete while process models for the particular product developed as part of the engineering project was 80% complete. In such an example the criterion score for the ‘system requirements documentation’ analysis criterion can be set to ‘0.5’ while the criterion score for the ‘process model’ analysis criterion can be set to ‘0.8.’ In the example method of FIG. 2, receiving (208) a criterion score for each analysis criterion may be carried out, for example, by receiving input from a user such a requirements engineer identifying the criterion score for each analysis criterion, by calculating the criterion score for each analysis criterion, by any combination thereof, and so on.

The example method of FIG. 2 also includes calculating (210), by the engineering requirements analysis component (200), a project score for the engineering project in dependence upon the criterion score for each analysis criterion and the criteria weight for each analysis criterion. In the example method of FIG. 2, the project score represents the extent to which measurable objectives of the engineering project as a whole have been met. Calculating (210) a project score for the engineering project may therefore be carried out by using the criterion score for each analysis criterion in every analysis criteria area and applying the criteria weight for each analysis criterion to each criterion score to determine a properly weighted, cumulative score for the entire project.

Consider the example described above with reference to Table 1 in which an engineering project included two analysis criteria areas containing a total of five analysis criteria. In such an example, assume the following criteria scores for each analysis criterion: the ‘process model’ analysis criterion has a score of 0.6; the ‘user documentation’ analysis criterion has a score of 0.3; the ‘system requirements documentation’ analysis criterion has a score of 0.9; the ‘errors’ analysis criterion has a score of 0.2; and the ‘dependencies’ analysis criterion has a score of 0.7. In such an example, accounting for the criterion weight of each analysis criterion, the project score would be calculated (210) as:

Project score=(0.2*0.6)+(0.1*0.3)+(0.2*0.9)+(0.3*0.2)+(0.1*0.7)=0.36

Readers will appreciate that the examples described above are merely given for purposes of illustration. Readers will appreciate that engineering projects may include many more analysis criteria areas that include many more analysis criteria. Likewise, weighting schemes may be designed to normalize the project score, for example, by requiring that the sum of all criteria weight values equals a predetermined value (e.g., 1).

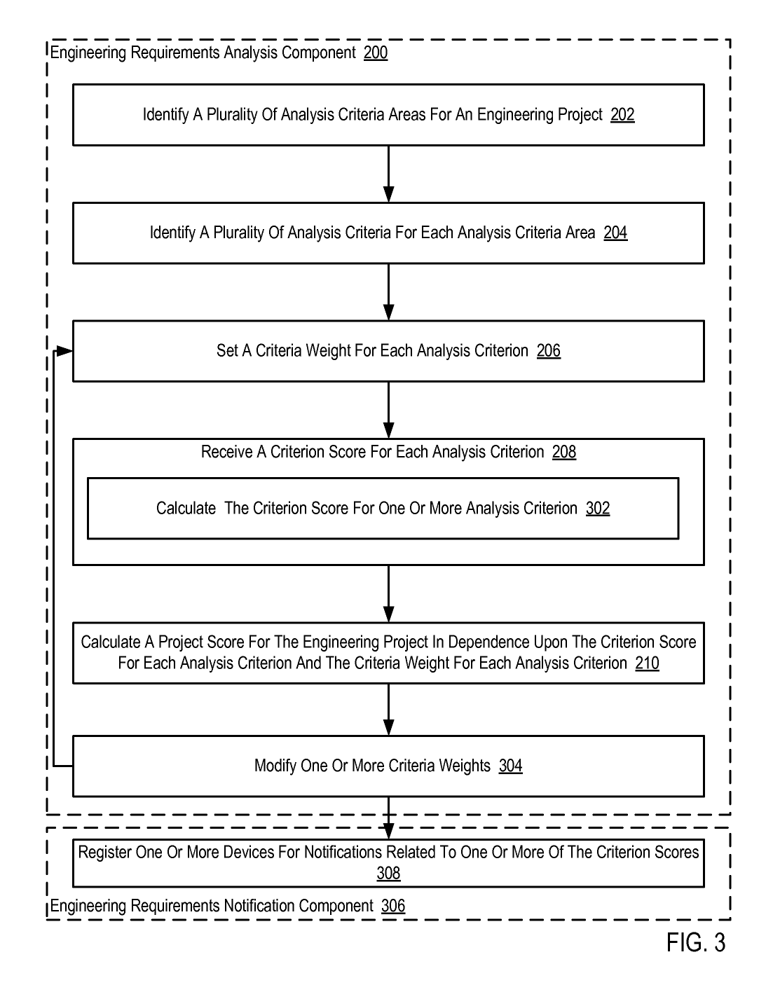

For further explanation, FIG. 3 sets forth a flow chart illustrating a further example method for analyzing engineering requirements according to embodiments of the present invention. The method of FIG. 3 is similar to the method of FIG. 2 as it also includes identifying (202) a plurality of analysis criteria areas for an engineering project, identifying (204) a plurality of analysis criteria for each analysis criteria area, setting (206) a criteria weight for each analysis criterion, receiving (208) a criterion score for each analysis criterion, and calculating (210) a project score for the engineering project in dependence upon the criterion score for each analysis criterion and the criteria weight for each analysis criterion.

In the example method of FIG. 3, receiving (208) a criterion score for each analysis criterion can include calculating (302), by the engineering requirements analysis component (200), the criterion score for one or more analysis criterion. In the example method of FIG. 3, calculating (302) the criterion score for one or more analysis criterion may be carried out, for example, by examining information associated with a particular analysis criterion. Consider an example in which the particular analysis criterion is a performance metric associated with a particular software component developed as part of an engineering project. In such an example, calculating (302) the criterion score may be carried out, for example, by executing a predetermined number of iterations of the software component and determining the average amount of time to execute an iteration of the software component. In another example in which the particular analysis criterion is an error rate metric associated with a particular software component developed as part of an engineering project, calculating (302) the criterion score may be carried out by executing a predetermined number of iterations of the software component and determining the percentage of iterations that generated an error.

The example method of FIG. 3 also includes modifying (304), by the engineering requirements analysis component (200), one or more criteria weights. As an engineering project progress, certain analysis criteria may become more important while other criteria may become less important. For example, analysis criteria related to testing a product that is developed during an engineering project may become more important during later stages in the engineering project lifecycle while analysis criteria associated with design metrics may become less important during later stages in the engineering project lifecycle as design decisions have long been made. In the example method of FIG. 3, modifying (304) one or more criteria weights may be carried out, for example, by modifying values in a criteria weight table as illustrated above with respect to Table 1.

The example method of FIG. 3 also includes registering (308), by an engineering requirements notification component (306), one or more devices for notifications related to one or more of the criterion scores. In the example method of FIG. 3, the engineering requirements notification component (306) may be embodied as a module of computer program instructions executing on computer hardware. The engineering requirements notification component (306) may be configured to send notification messages, such as an short message service (‘SMS’) message, an electronic mail message, a multimedia message, an instant message, and so on to one or more data communications devices such as a smartphone, laptop, tablet computer, and the like.

In the example method of FIG. 3, various team members of an engineering project will have varying levels of interest in different analysis criteria. For example, a team member tasked with technical writing aspects of an engineering project may have a higher level of interest in analysis criteria associated with the development of user documentation for the engineering project than a team member tasked with quality assurance and testing aspects of the engineering project. As such, various team members of an engineering project will have varying levels of interest in receiving notifications related to a particular analysis criterion. In order to avoid bombarding an uninterested team member with notifications related to a particular analysis criterion that is of little interest to the team member, that team member's devices may be unregistered with respect to notifications associated with a particular analysis criterion. Likewise, each team member can register (308) one or more devices for notifications related to one or more of the analysis criteria.

In the example method of FIG. 3, registering (308) one or more devices for notifications related to one or more of the criterion scores may be carried out, for example, by maintaining a table or other data structure that associates each analysis criterion with a list of registered devices. Entries in such a table can include, for example, a device identifier, an analysis criterion identifier, as well as contact information for a registered device. Contact information for a registered device can include a phone number, an IP address, an electronic mail address representing an active email account on the device, and so on.

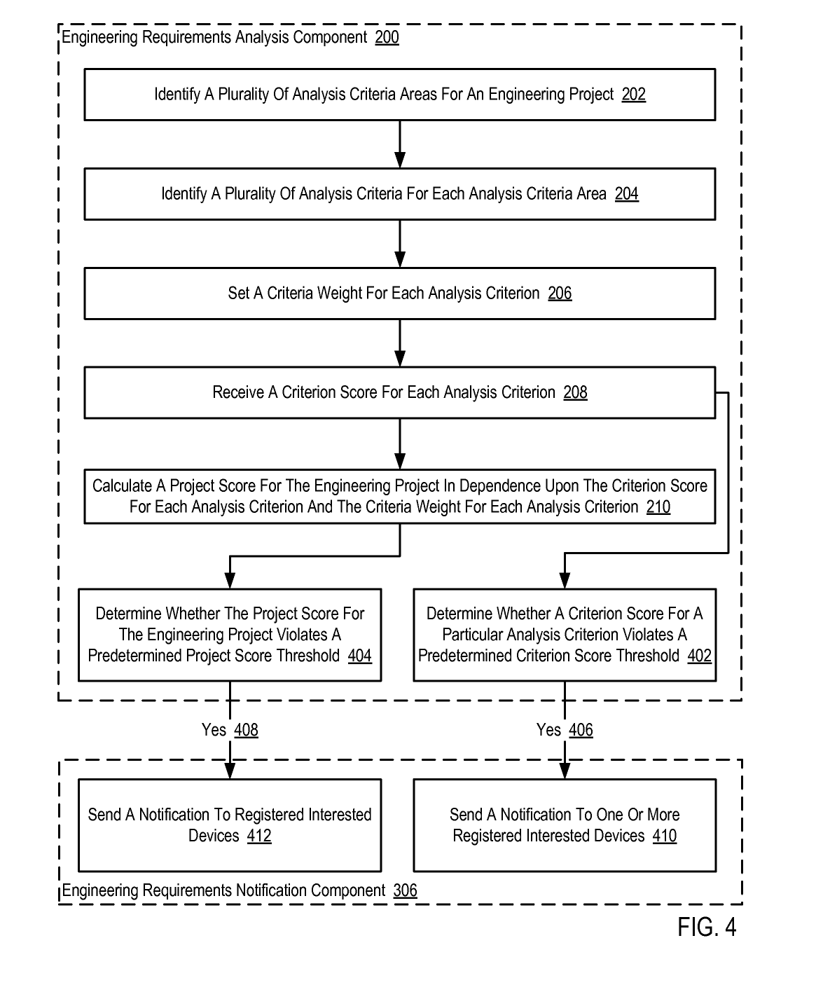

For further explanation, FIG. 4 sets forth a flow chart illustrating a further example method for analyzing engineering requirements according to embodiments of the present invention. The method of FIG. 4 is similar to the method of FIG. 2 as it also includes identifying (202) a plurality of analysis criteria areas for an engineering project, identifying (204) a plurality of analysis criteria for each analysis criteria area, setting (206) a criteria weight for each analysis criterion, receiving (208) a criterion score for each analysis criterion, and calculating (210) a project score for the engineering project in dependence upon the criterion score for each analysis criterion and the criteria weight for each analysis criterion.

The example method of FIG. 4 also includes determining (402), by the engineering requirements analysis component (200), whether a criterion score for a particular analysis criterion violates a predetermined criterion score threshold. In the example method of FIG. 4, the predetermined criterion score threshold represents a value that distinguishes an acceptable criterion score from an unacceptable criterion score. The predetermined criterion score threshold may be specified, for example, table or other data structure that associates a particular analysis criterion with the predetermined criterion score threshold.

In the example method of FIG. 4, the predetermined criterion score threshold may be embodied, for example, as a maximum acceptable value such that determining (402) whether a criterion score for a particular analysis criterion violates the predetermined criterion score threshold is carried out by determining whether the criterion score for a particular analysis criterion exceeds the predetermined criterion score threshold. Alternatively, the predetermined criterion score threshold may also be embodied as a minimum acceptable value such that determining (402) whether a criterion score for a particular analysis criterion violates the predetermined criterion score threshold is carried out by determining whether the criterion score for a particular analysis criterion is less than the predetermined criterion score threshold.

The example method of FIG. 4 also includes sending (410), by an engineering requirements notification component (306), a notification to one or more registered interested devices. In the example method of FIG. 4, sending (410) a notification to one or more registered interested devices can be carried out in response to determining that the criterion score for the particular analysis criterion does (406) violate the predetermined criterion score threshold. In the example method of FIG. 4, the notification may include an identifier of the analysis criterion whose criterion score was unacceptable, the value of the criterion score, the value of the predetermined criterion score threshold, and so on. Such a notification may be sent over one or more data communications networks supported by the recipient device such as, for example, an IP network, a telephony network, and so on.

The example method of FIG. 4 also includes determining (404), by the engineering requirements analysis component (200), whether the project score for the engineering project violates a predetermined project score threshold. In the example method of FIG. 4, the predetermined project score threshold represents a value that distinguishes an acceptable project score from an unacceptable project score. The predetermined project score threshold may be specified, for example, table or other data structure that associates an engineering project with the predetermined project score threshold.

In the example method of FIG. 4, the predetermined project score threshold may be embodied, for example, as a maximum acceptable value such that determining (404) whether the project score for the engineering project violates a predetermined project score threshold is carried out by determining whether the project score exceeds the predetermined project score threshold. Alternatively, the predetermined project score threshold may also be embodied as a minimum acceptable value such that determining (404) whether the project score for the engineering project violates a predetermined project score threshold is carried out by determining whether the project score is less than the predetermined project score threshold.

The example method of FIG. 4 also includes sending (412), by an engineering requirements notification component (306), a notification to registered interested devices. In the example method of FIG. 4, sending (412) a notification to registered interested devices may be carried out in response to determining that the project score for the engineering project does (408) violate the predetermined project score threshold. In the example method of FIG. 4, the notification may include an identifier of the engineering project whose project score was unacceptable, the value of the project score, the value of the predetermined project score threshold, and so on. Such a notification may be sent over one or more data communications networks supported by the recipient device such as, for example, an IP network, a telephony network, and so on.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method of analyzing engineering requirements, the method comprising:
identifying, by an engineering requirements analysis component, a plurality of analysis criteria areas for an engineering project;
identifying, by the engineering requirements analysis component, a plurality of analysis criteria for each analysis criteria area;
setting, by the engineering requirements analysis component, a criteria weight for each analysis criterion;
receiving, by the engineering requirements analysis component, a criterion score for each analysis criterion; and
calculating, by the engineering requirements analysis component, a project score for the engineering project in dependence upon the criterion score for each analysis criterion and the criteria weight for each analysis criterion.

2. The method of claim 1 further comprising modifying, by the engineering requirements analysis component, one or more criteria weights.

3. The method of claim 1 further comprising:
determining, by the engineering requirements analysis component, whether a criterion score for a particular analysis criterion violates a predetermined criterion score threshold; and
responsive to determining that the criterion score for the particular analysis criterion violates the predetermined criterion score threshold, sending, by an engineering requirements notification component, a notification to one or more registered interested devices.

4. The method of claim 1 further comprising:
determining, by the engineering requirements analysis component, whether the project score for the engineering project violates a predetermined project score threshold; and
responsive to determining that the project score for the engineering project violates the predetermined project score threshold, sending, by an engineering requirements notification component, a notification to registered interested devices.

5. The method of claim 1 wherein receiving the criterion score for each analysis criterion further comprises calculating, by the engineering requirements analysis component, the criterion score for one or more analysis criterion.

6. The method of claim 1 further comprising registering, by an engineering requirements notification component, one or more devices for notifications related to one or more of the criterion scores.

7. An apparatus for analyzing engineering requirements, the apparatus comprising a computer processor, a computer memory operatively coupled to the computer processor, the computer memory having disposed within it computer program instructions that, when executed by the computer processor, cause the apparatus to carry out the steps of:
identifying, by an engineering requirements analysis component, a plurality of analysis criteria areas for an engineering project;
identifying, by the engineering requirements analysis component, a plurality of analysis criteria for each analysis criteria area;
setting, by the engineering requirements analysis component, a criteria weight for each analysis criterion;
receiving, by the engineering requirements analysis component, a criterion score for each analysis criterion; and
calculating, by the engineering requirements analysis component, a project score for the engineering project in dependence upon the criterion score for each analysis criterion and the criteria weight for each analysis criterion.

8. The apparatus of claim 7 further comprising computer program instructions that, when executed by the computer processor, cause the apparatus to carry out the step of modifying, by the engineering requirements analysis component, one or more criteria weights.

9. The apparatus of claim 7 further comprising computer program instructions that, when executed by the computer processor, cause the apparatus to carry out the steps of:
determining, by the engineering requirements analysis component, whether a criterion score for a particular analysis criterion violates a predetermined criterion score threshold; and
responsive to determining that the criterion score for the particular analysis criterion violates the predetermined criterion score threshold, sending, by an engineering requirements notification component, a notification to one or more registered interested devices.

10. The apparatus of claim 7 further comprising computer program instructions that, when executed by the computer processor, cause the apparatus to carry out the steps of:
determining, by the engineering requirements analysis component, whether the project score for the engineering project violates a predetermined project score threshold; and
responsive to determining that the project score for the engineering project violates the predetermined project score threshold, sending, by an engineering requirements notification component, a notification to registered interested devices.

11. The apparatus of claim 7 wherein receiving the criterion score for each analysis criterion further comprises calculating, by the engineering requirements analysis component, the criterion score for one or more analysis criterion.

12. The apparatus of claim 7 further comprising computer program instructions that, when executed by the computer processor, cause the apparatus to carry out the step of registering, by an engineering requirements notification component, one or more devices for notifications related to one or more of the criterion scores.

13. A computer program product for analyzing engineering requirements, the computer program product including a computer readable medium, the computer program product comprising computer program instructions that, when executed, cause a computer to carry out the steps of:
identifying, by an engineering requirements analysis component, a plurality of analysis criteria areas for an engineering project;
identifying, by the engineering requirements analysis component, a plurality of analysis criteria for each analysis criteria area;
setting, by the engineering requirements analysis component, a criteria weight for each analysis criterion;
receiving, by the engineering requirements analysis component, a criterion score for each analysis criterion; and
calculating, by the engineering requirements analysis component, a project score for the engineering project in dependence upon the criterion score for each analysis criterion and the criteria weight for each analysis criterion.

14. The computer program product of claim 13 further comprising computer program instructions that, when executed, cause the computer to carry out the step of modifying, by the engineering requirements analysis component, one or more criteria weights.

15. The computer program product of claim 13 further comprising computer program instructions that, when executed, cause the computer to carry out the steps of:
determining, by the engineering requirements analysis component, whether a criterion score for a particular analysis criterion violates a predetermined criterion score threshold; and
responsive to determining that the criterion score for the particular analysis criterion violates the predetermined criterion score threshold, sending, by an engineering requirements notification component, a notification to one or more registered interested devices.

16. The computer program product of claim 13 further comprising computer program instructions that, when executed, cause the computer to carry out the steps of:
determining, by the engineering requirements analysis component, whether the project score for the engineering project violates a predetermined project score threshold; and
responsive to determining that the project score for the engineering project violates the predetermined project score threshold, sending, by an engineering requirements notification component, a notification to registered interested devices.

17. The computer program product of claim 13 wherein receiving the criterion score for each analysis criterion further comprises calculating, by the engineering requirements analysis component, the criterion score for one or more analysis criterion.

18. The computer program product of claim 13 further comprising computer program instructions that, when executed, cause the computer to carry out the step of registering, by an engineering requirements notification component, one or more devices for notifications related to one or more of the criterion scores.

19. The computer program product of claim 13 wherein the computer readable medium comprises a signal medium.

20. The computer program product of claim 13 wherein the computer readable medium comprises a storage medium.
